(19) United States
(12) Patent Application Publication
(10) Pub. No.: US 2008/0289077 A1
(43) Pub. Date: Nov. 27, 2008

(54) SAFETY GARMENT

(76) Inventors: Jeffery L. Enlund, Louisburg, MO (US); Curt N. Rankin, Lebanon, MO (US); Roger D. Rankin, II, Buffalo, MO (US); Brenda L. Rankin, Buffalo, MO (US)

Correspondence Address: HOVEY WILLIAMS LLP, 10801 Mastin Blvd., Suite 1000, Overland Park, KS, 66210, US

(21) Appl. No.: 11/754,165

(22) Filed: May 25, 2007

(51) Int. Cl. A62B 17/00; A41D 1/00; A41D 1/02; A41D 27/00

(52) U.S. Cl. 2/81; 2/274; 2/69; 2/93

(57) ABSTRACT

A safety garment (10) operable to be worn by a wearer for cooling and protection. The safety garment (10) generally includes a protective outer layer (12), a first generally impermeable middle layer (14) coupled with the outer layer (12), an inner layer (16) coupled with the first middle layer (14) and operable to be worn against the wearer, a plurality of apertures (18) formed through the first middle layer (14) and inner layer (16), and an inlet (20) coupled with the outer layer (12). The inlet (12) is operable to receive cooling air and direct the cooling air between the outer layer (12) and first middle layer (14) to enable the cooling air to pass through at least one of the apertures (18) to cool the wearer.

### BACKGROUND

1. Field

Embodiments of the present invention relate to safety garments. More particularly, various embodiments of the invention provide a safety garment operable to cool a wearer by receiving cooling air and directing the cooling air towards the wearer's body.

2. Description of the Related Art

Individuals exposed to high temperature environments, such as technicians responsible for maintaining boilers, often wear heat resistant suits and other safety garments for protection. Some safety garments include air circulation systems that allow individuals to function in high temperature environments by circuiting cooling air within or through the garments. Unfortunately, such garments are commonly bulky and restrict wearer movement. Thus, individuals who desire to move freely are often unable to utilize safety garments for cooling purposes. This is particularly problematic in relatively lower extreme heat environments (e.g., those involving support personnel positioned outside a boiler during maintenance), where mobility and prolonged exposure to “low heat” conditions (e.g., 95-130° F.) are mandatory.

### SUMMARY

Embodiments of the present invention solve the above-described problems and provide a distinct advance in the art of safety garments. More particularly, various embodiments of the invention provide a safety garment operable to cool a wearer by receiving cooling air and directing the cooling air towards the wearer's body.

In various embodiments, the safety garment is operable to be worn by a wearer and generally includes a protective outer layer, a first generally impermeable middle layer coupled with the outer layer, an inner layer coupled with the first middle layer and operable to be worn against the wearer, a plurality of apertures formed through the first middle layer and inner layer, and an inlet coupled with the outer layer. The inlet is operable to receive cooling air and direct the cooling air between the outer layer and first middle layer to enable the cooling air to pass through at least one of the apertures to cool the wearer.

In another aspect, the safety garment generally comprises a protective outer layer; a first generally impermeable middle layer; a second generally impermeable middle layer coupled with the outer layer; and an inner layer coupled with the first middle layer and operable to be worn against the wearer. A plurality of apertures are formed through the first middle layer and inner layer and an inlet is coupled with the outer layer. The inlet is operable to receive cooling air and direct the cooling air between the first middle layer and second middle layer to enable the cooling air to pass through at least one of the apertures to cool the wearer. A plurality of binding elements each pass through the outer layer, first middle layer, second middle layer, and inner layer to join portions of the layers in a superimposed relatively fixed relationship.

In another aspect, the safety garment generally comprises a flame-resistant outer layer including a reinforced portion; a first generally impermeable middle layer; a second generally impermeable middle layer coupled with the outer layer; and a flame-resistant inner layer coupled with the first middle layer and operable to be worn against the wearer. A plurality of apertures are formed through the first middle layer and inner layer. At least a first set of the apertures are linearly disposed along the first middle layer and inner layer and the first middle layer and inner layer are stitched together along opposite sides of the first set of apertures. An inlet is coupled with the reinforced portion of the outer layer and is operable to receive cooling air and direct the cooling air between the first middle layer and second middle layer to enable the cooling air to pass through at least one of the apertures to cool the wearer. A plurality of binding elements each pass through the outer layer, first middle layer, second middle layer, and inner layer to join portions of the layers in a superimposed relatively fixed relationship.

It is to be understood that both the foregoing general description and the following detailed description are exemplary and explanatory only and are not necessarily restrictive of the invention claimed. The accompanying drawings, which are incorporated in and constitute a part of the specification, illustrate embodiments of the invention and together with the general description, serve to explain the principles of the invention.

### BRIEF DESCRIPTION OF THE DRAWING FIGURES

Various embodiments of the present invention are described in detail below with reference to the attached drawing figures, wherein:

FIG. 1 is a front perspective view of a safety garment configured in accordance with various embodiments of the present invention;

FIG. 2 is a rear perspective view of the safety garment of FIG. 1;

FIG. 3 is a front perspective view of an exemplary cooling device coupled with a reinforced portion of the safety garment of FIG. 1;

FIG. 4 is a rear sectional view showing the reinforced portion of FIG. 3 in more detail;

FIG. 5 is a side sectional side view showing the reinforced portion and cooling device of FIGS. 3-4;

FIG. 6a is a front view of a right side of a sub-unit formed by middle layers of the safety garment of FIG. 1;

FIG. 6b is a rear view of the sub-unit of FIG. 5a;

FIG. 6c is a front view of a left side of the sub-unit of FIG. 5a;

FIG. 7 is an environmental view of various layers of some embodiments of the safety garment of FIG. 1;

FIG. 8 is an environmental view of various layers of other embodiments of the safety garment of FIG. 1; and

FIG. 9 is a perspective view of a safety garment configured in accordance with various other embodiments of the present invention.

The drawing figures do not limit the present invention to the specific embodiments disclosed and described herein. The drawings are not necessarily to scale, emphasis instead being placed upon clearly illustrating various embodiments of the invention.

### DETAILED DESCRIPTION

The following detailed description of various embodiments of the invention references the accompanying drawings which illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

Various embodiments of the present invention provide a safety garment 10 operable to be worn by a wearer. The safety garment 10 generally includes a protective outer layer 12, a first middle layer 14 coupled with the outer layer 12, an inner layer 16 coupled with the first middle layer 14 and operable to be worn against the wearer, a plurality of apertures 18 formed through the first middle layer 14 and inner layer 16, and an inlet 20 operable to receive cooling air and direct the cooling air through at least one of the apertures 18 to cool the wearer.

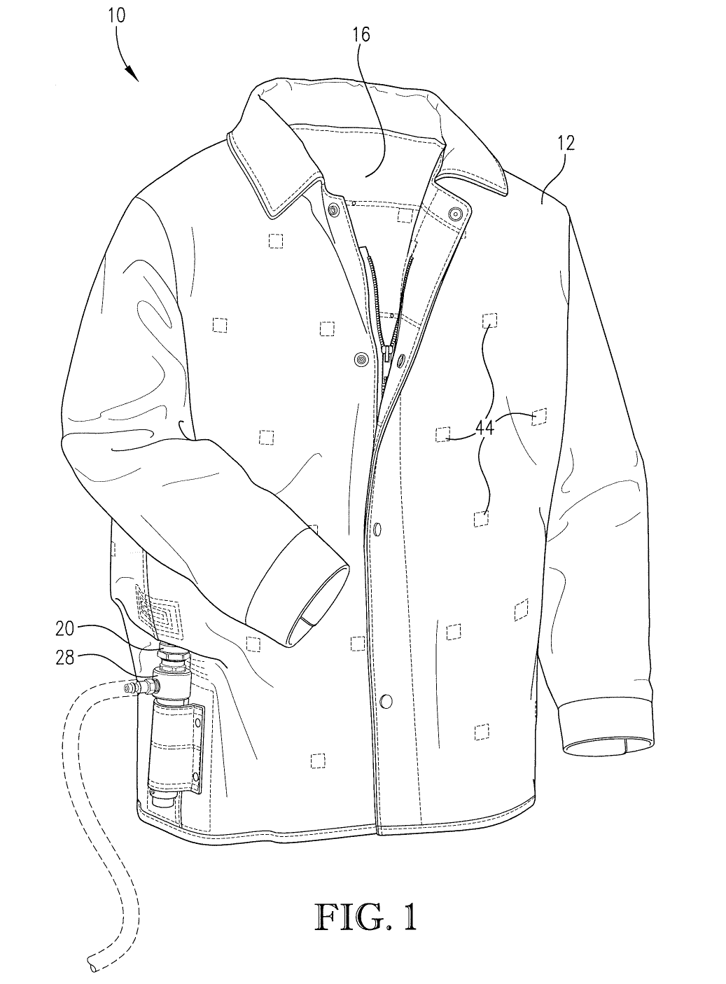

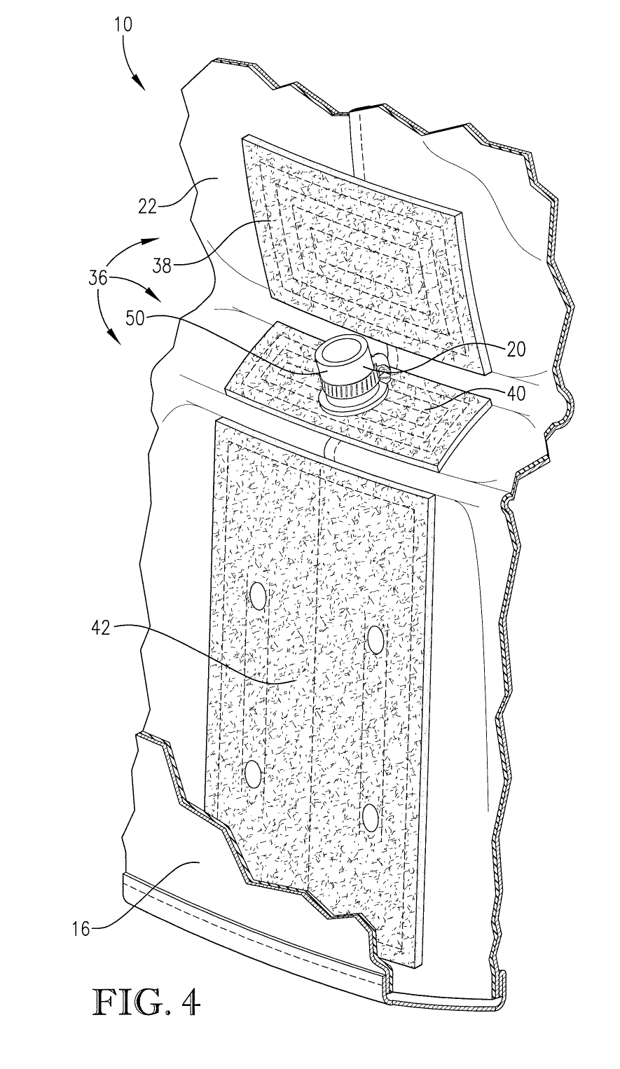

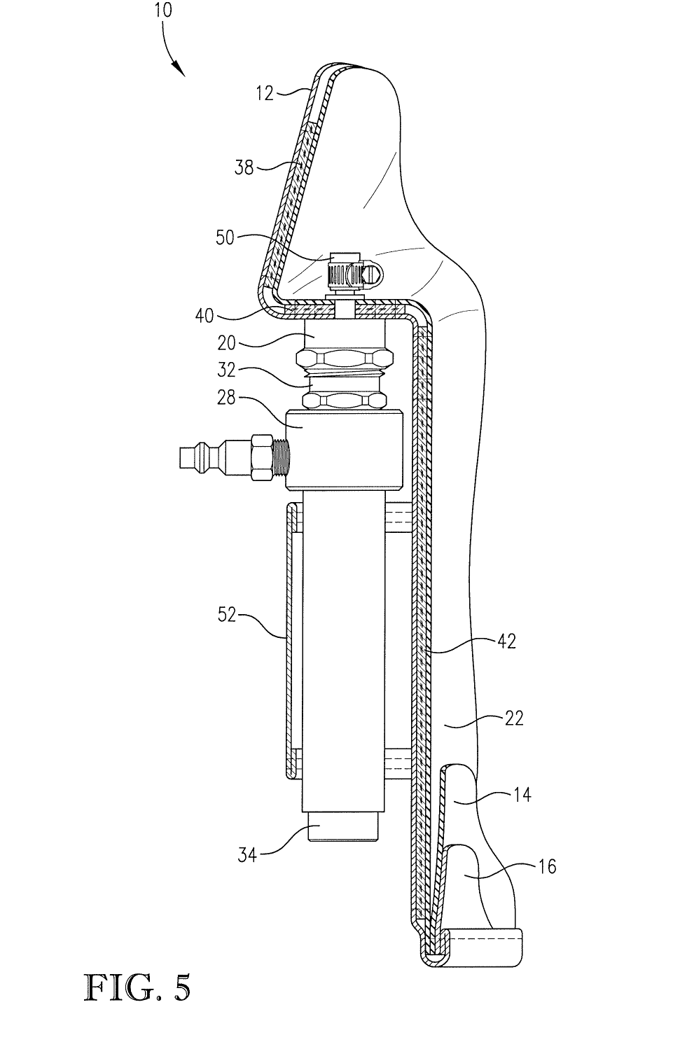

As is discussed in more detail below and as illustrated in FIGS. 1-8, the safety garment 10 may be configured as a jacket operable to be worn on the wearer's torso. However, the safety garment 10 may be configured in any configuration to be worn by the wearer in any manner. Thus, in some embodiments, the safety garment 10 many be configured as a hat, a shirt, a poncho, a coverall, a vest, a sleeve, a glove, an undergarment, a pair of shorts, a pair of pants, a sock, a boot, combinations and portions thereof, and the like.

The outer layer 12 forms at least a portion of the outer surface of the safety garment 10 and is adapted to protect the wearer. In some embodiments, the outer layer 12 may be comprised of a flame-resistant material. For example, the outer layer 12 may be comprised at least partially of NOMEX® brand flame-resistant material. To enable a lightweight configuration of the safety garment 10, the outer layer 12 may be comprised at least partially of 6 ounce NOMEX® in some embodiments. However, the outer layer 12 may additionally or alternatively be comprised of other flame and/or heat resistant materials, such as various synthetic and natural aramid fibers and/or aluminized aromatic polyamide fibers including TWARON® and KEVLAR®.

Additionally or alternatively, the outer layer 12 may be comprised of a durable and puncture-resistant material that is also flame resistant, such as leather. However, the outer layer 12 may be comprised of any material, including cloth, natural and synthetic fibers, plastics, foils, combinations thereof, and the like, and is not limited to the specific examples articulated above, although the use of a flame-resistant material is most preferred.

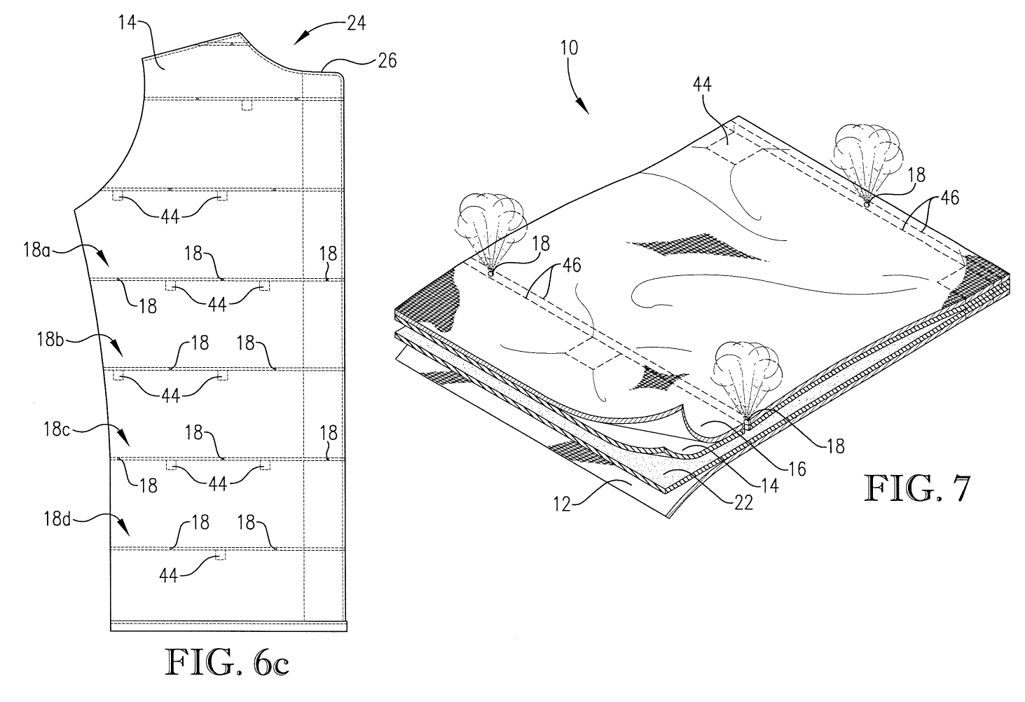

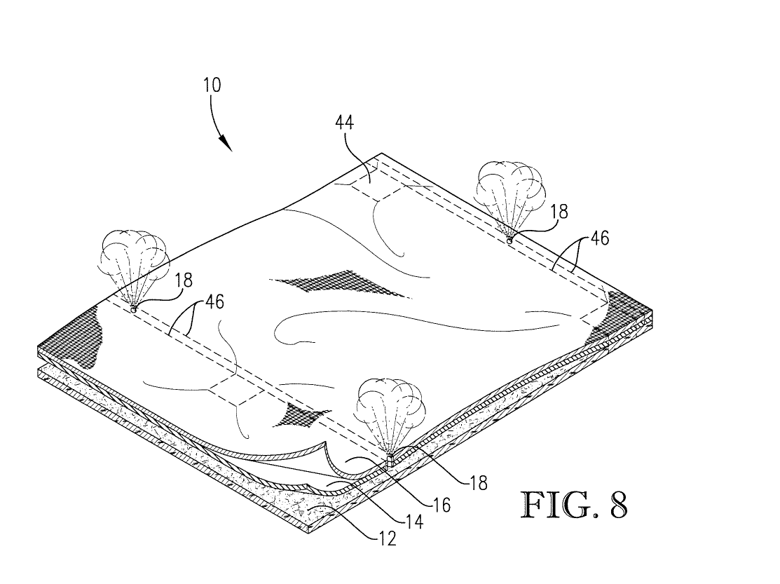

The first middle layer 14 may be directly or indirectly coupled with the outer layer 14. For example, in some embodiments, as illustrated in FIG. 8, the first middle layer 14 may directly abut portions of the outer layer 12. In other embodiments, as illustrated in FIG. 7, other garment layers may be positioned between the outer layer 12 and first middle layer 14. The first middle layer 14 may be removably or fixedly coupled with the outer layer 12 along its periphery and/or at various locations spaced from its periphery, as is discussed in more detail below.

In various embodiments, the first middle layer 14 is generally impermeable to gases such as the cooling air provided through the inlet 20. Thus, in some embodiments the first middle layer 14 may be comprised of generally gas impermeable materials such a laminated chemical moisture barrier, including, for example, vinyl, polyolefins such as polyethylene and polypropylene, other flexible plastic sheet materials, combinations thereof, and the like. However, in embodiments where the first middle layer 14 is generally impermeable to gases, the first middle layer 14 may be comprised of any material that generally resists the transmission of gases such as the cooling air.

In some embodiments, the safety garment 10 may additionally include a second middle layer 22 positioned between the outer layer 12 and first middle layer 14 as is illustrated in FIG. 7. The second middle layer 22 may be fixedly or removably coupled with one or both of the outer layer 12 and first middle layer 14 along its periphery and/or at various locations spaced from its periphery.

The second middle layer 22 may also be generally impermeable to gases such as the cooling air provided through the inlet 20. Thus, the second middle layer 22 may be comprised of the same or similar material as the first middle layer 14, including the various laminated chemical moisture barriers discussed above. However, in some embodiments the second middle layer 22 may be gas permeable and/or comprised of materials different from those comprising the first middle layer 14.

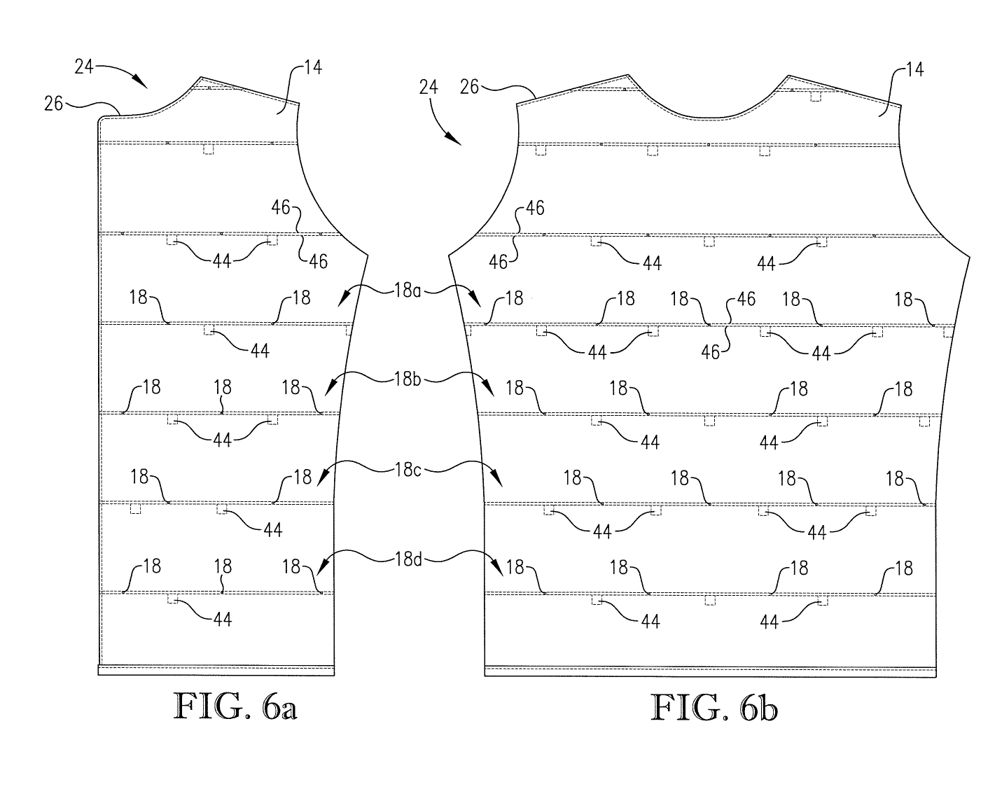

As illustrated in FIGS. 6a through 6c, the middle layers 14, 22 may be coupled together to form an integral sub-unit 24 of the safety garment 10. For example, the middle layers 14, 22 may be similarly dimensioned and superimposed for coupling along their peripheries. Thus, for instance, the middle layers 14, 22 may be coupled together by a seam 26 extending along and/or through their peripheries. The sub-unit 24 may additionally or alternatively be formed by joining the middle layers 14, 22 at locations spaced from their peripheries, as is discussed in more detail below.

In some embodiments where the safety garment 10 is adapted as a jacket, the sub-unit 24 may present a vest-like configuration for inclusion within the safety garment 10 and positioning over the wearer's torso. The sub-unit 24 is fixed to the outer layer 12 and inner layer 16 utilizing permanent coupling elements such as a seam.

The inner layer 16 is coupled with the first middle layer 14 and is operable to be worn against the wearer. The inner layer 16 may be directly coupled with the first middle layer 14 such as where the inner layer 16 and first middle layer 14 are at least partially sewn together. However, in other embodiments, the inner layer 16 may additionally or alternatively be fixedly or removably indirectly coupled with the first middle layer 14 such as where the inner layer 16 is sewn to the outer layer 12 and the sub-unit 24 is positioned therebetween.

The inner layer 16 may be comprised of any material suitable to be worn against the wearer. Thus, for example, the inner layer 16 may be comprised of various cloths and fabrics. In some embodiments, the inner layer 16 may be a protective layer comprised of the same or similar materials as the outer layer 12, such as NOMEX®, leather, and/or the like.

The apertures 18 are formed through the first middle layer 14 and inner layer 16 to enable cooling air to pass to the wearer's body, as is discussed in more detail below. The apertures 18 may include any gas permeable paths formed through at least portions of the first middle layer 14 and inner layer 16. Thus, in some embodiments, as illustrated in FIGS. 6a through 6c, the apertures 18 may include a plurality of holes formed through the first middle layer 14 and inner layer 16. However, in other embodiments, a gas-permeable membrane may be positioned in one or more of the apertures 18 to allow cooling air to flow from the inlet 20 and through the gas permeable membranes to the wearer.

At least some of the apertures 18 are preferably positioned such that when cooling air is directed between the middle layers 14, 22, or outer layer 12 and first middle layer 14, at least a portion of the cooling air passes through the apertures 18 and towards the wearer as opposed to through the outer layer 12 and away from the wearer. Thus, it is most preferable for none of the apertures 18 to be positioned on the outer layer 12 and second middle layer 22 so that correct flow of the cooling air is facilitated.

As illustrated in FIGS. 6a through 6c, at least some of the apertures may be linearly disposed on the first middle layer 14 and inner layer 16. For example, a first set of the apertures 18a may be linearly disposed along the first middle layer 14 and inner layer 16 in a generally horizontal orientation corresponding to a common line of reference. Other sets of apertures 18b, 18c, 18d, may also be linearly disposed along the first middle layer 14 and inner layer 16 such that each of the sets 18a, 18b, 18c, 18d, are generally parallel to each other. The various sets 18a, 18b, 18c, 18d may additionally or alternatively be arranged vertically or diagonally in overlapping and non-overlapping configurations and are not limited to the illustrated horizontal configuration. Utilization of the aperture sets 18a, 18b, 18c, 18d, may be desirable in some embodiments to ensure the generally uniform distribution of cooling air to portions of the wearer's body.

As is also illustrated in FIGS. 6a through 6c, the first middle layer 14 and inner layer 16 may be coupled together in proximity to one or more of the apertures 18. Such a configuration enables the layers 14, 16 to remain substantially superimposed in a relatively fixed relationship even during wearer movement, thereby preventing the cooling air from being restricted by the blocking of the apertures 18. In some embodiments, the first middle layer 14 and inner layer 16 may be joined together generally parallel to one or more of the aperture sets 18a, 18b, 18c, 18d. Preferably, the first middle layer 14 and inner layer 16 are stitched together along opposite sides of each of the aperture sets 18a, 18b, 18c, 18d. For example, stitching lines 46 may be positioned on opposite sides of each aperture set 18a, 18b, 18c, 18d, and extend generally parallel to the linear arrangement of the aperture sets 18a, 18b, 18c, 18d.

However, the first middle layer 14 and inner layer 16 may be coupled together in any manner to enable at least partial alignment of the apertures 18. For example, the inner layer 16 and first middle layer 14 may include various reciprocal mating elements, such as VELCRO®-like fasteners, snaps, hooks, buttons, zippers, latches, combinations thereof, and the like.

In embodiments where the various layers are formed of lightweight materials such as leather, NOMEX®, flexible plastic sheet materials, combinations thereof, and the like, the safety garment 10 provides a lightweight configuration that may be easily worn by the wearer without substantially restricting the wearer's movement as compared to full heat suits, such as those disclosed by U.S. Pat. No. 5,421,326, which is incorporated herein by reference. To further reduce the weight of the safety garment 10, portions of the garment 10 may include only some of the layers 12, 14, 16, and 22. For example, in embodiments where the safety garment 10 is a jacket, the sleeves of the jacket may be comprised of only the outer layer 12 to facilitate arm movement. Thus, embodiments of the safety garment 10 enable the wearer to easily engage in physical activity, such as welding and machining, while wearing the garment 10.

The inlet 20 is coupled with the outer layer 12 and is operable to receive cooling air. The inlet 20 may be adapted to receive cooling air from various sources, devices, and systems. For example, the inlet 20 may be configured to couple with an air supply hose that transfers cooling air from a supply to the safety garment 10. The inlet 20 may additionally or alternatively be adapted to couple with portable air conditioning systems and supplies. Thus, the inlet 20 may comprise any elements or combination of elements that allow air to pass from an external source and at least partially through the outer layer 12. In some embodiments, the inlet 20 may comprise a threaded outer portion 48 operable to couple with various air supplies and an inner portion 50 extending through the outer layer 12. The inner portion 50 preferably includes insulating elements to limit condensation and heat gain and to prevent the inner portion 50 from puncturing or otherwise damaging portions of the middle layers 14, 22 and inner layer 16. More preferably, the inner portion 50 includes a barbed connection and a hose element secured thereto with a hose clamp or other connecting device such as steel bond or epoxy. The barbed connection may be formed from rigid metal and the hose element may present a soft and/or flexible configuration. The garment 10 may include one inlet or a plurality of inlets to receive cooling air from a plurality of sources.

In some embodiments, the safety garment 10 may include a vortex cooling device 28 operable to couple with the inlet 20 to provide cooling air thereto. The vortex cooling device 28 may be any device operable to receive compressed air from an external supply and separate the compressed air into hot and cold streams. Thus, in some embodiments the vortex cooling device 28 may be a Ranque-Hilsch vortex tube, such as those disclosed in U.S. Pat. Nos. 1,952,281 and 4,240,261, which are incorporated herein by reference.

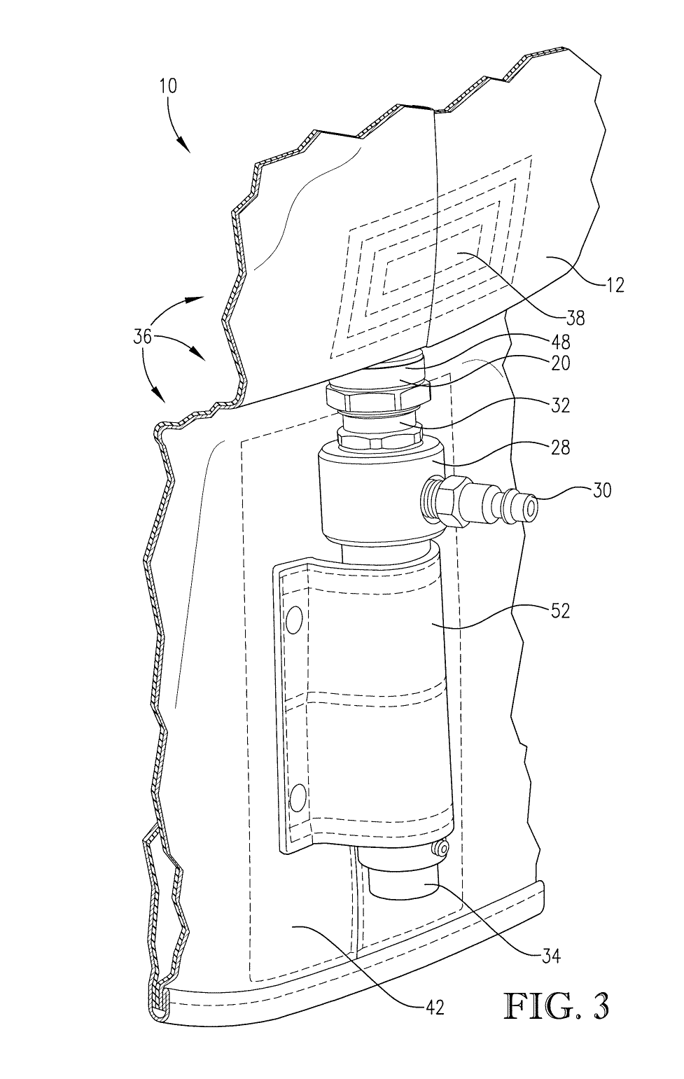

As illustrated in FIG. 3, the vortex cooling device 28 may include a compressed air input 30, a cool air output 32, and a hot air output 34. The compressed air input 30 is operable to couple with an air supply hose or air compressor to receive compressed air. The cool air output 32 is operable to fixedly or removably couple with the inlet 20 to provide the cooling air thereto. The hot air output 34 is operable to output hot air resulting from the vortex process. In some embodiments, compressed air may be received by the compressed air input 30 at approximately twenty-one degrees Celsius, the cool air output 32 may output cooling air at approximately negative thirty-four degrees Celsius, and the hot air output 34 may output hot air at approximately seventy-six degrees Celsius. As should be appreciated, the above values merely illustrate an exemplary performance of the vortex cooling device 28 and any fixed or variable amount of cooling and heating may be provided by the vortex cooling device 28. Further, as discussed above, the inlet 20 may couple with devices other than the vortex cooling device 28 to receive cooling air of any temperature.

To facilitate the coupling of the inlet 20 and outer layer 12, the outer layer 12 may include a reinforced portion 36. For example, in embodiments where the outer layer 12 is comprised of NOMEX® or other generally soft and pliable materials, the reinforced portion 36 may be positioned in proximity to the inlet 20 to prevent the inlet 20, or any devices coupled thereto, from damaging the outer layer 12. For example, a portion of the outer layer 12 may be reinforced with leather or any other generally rigid and durable material and the inlet 20 may be placed through the reinforced portion to prevent damage, such as tearing, to the outer layer 12.

As illustrated in FIGS. 3-5, the reinforced portion 36 may include a top portion 38, a middle portion 40, and a bottom portion 42 each coupled to an interior side of the outer layer 12. The inlet 20 is inserted through the middle portion 40 to prevent the outer layer 12 from being damaged when the inlet 20, and any equipment coupled thereto such as the vortex cooling device 28, are forced away from the garment 10. For example, as shown in FIG. 3, the vortex cooling device 28 may hang from the inlet 20 and middle portion 40 due to its weight and rigidity in comparison with the generally pliable and lightweight outer layer 12, thereby exerting a downward force on the outer layer 12. The middle portion 40 prevents the inlet 20 from being inadvertently removed from the outer layer 12 in response to this and other forces.

The top portion 38 is positioned above the middle portion 40 and protects the outer layer 12 from equipment coupled to the inlet 20. For example, the top portion 38 prevents the cool air output 32 of the vortex cooling device 28 from penetrating the outer layer 12 if the vortex cooling device 28 is shifted upwards. The top portion 38 may also be spaced from the middle portion 40 to enable the middle portion 40 to be angled away from the top portion 38 to facilitate the hanging and positioning of the vortex cooling device 28, as is illustrated in FIG. 3. Thus, the top portion 38 may both protect the outer layer 12 and facilitate the positioning and alignment of the inlet 20 and/or vortex cooling device 28.

The bottom portion 42 is positioned below the middle portion 40 and also protects the outer layer 12 from the inlet 20 and equipment coupled thereto. As illustrated in FIG. 3, the bottom portion 42 may be dimensioned to correspond to the dimensions of the vortex cooling device 28 such that the bottom portion 42 extends beyond the width and length of the vortex cooling device 28 when coupled with the inlet 20.

In some embodiments, the bottom portion 42 may also be positioned in proximity to the hot air output 34 of the vortex cooling device 28 to prevent potentially hot air from damaging the outer layer 12 and/or irritating the wearer. Thus, for example, the bottom portion 42 may be positioned at least partially behind the hot air output 34 to prevent hot air from penetrating the outer layer 12 and reaching the wearer.

To ensure that the vortex cooling device 28 is properly positioned with respect to the bottom portion 42, the bottom portion 42 may include a retaining member to retain at least a portion of the vortex cooling device 28. For example, the retaining member may include a belt or loop 52 that is riveted to the bottom portion 42 and which presents a gap for insertion of the vortex cooling device 28. Securing the vortex cooling device 28 with the retaining member and bottom portion 42 prevents damage to the inlet 20 and layers 12, 14, 16, and 22 should the vortex cooling device 28, or a supply line coupled thereto, be forced away from the safety garment 10.

The various layers 12, 14, 16, and/or 22 may be conventionally coupled together along their peripheries to form the safety garment 10 into a desired configuration. In some embodiments, the safety garment 10 may additionally or alternatively include one or more binding elements 44 that pass through the outer layer 12, first middle layer 14, and inner layer 16 to join portions of the layers 12, 14, 16 in a superimposed relatively fixed relationship. In embodiments including the second middle layer 22, one or more of the binding elements 44 may pass through the outer layer 12, first middle layer 14, second middle layer 22, and inner layer 16 to join portions of the layers 12, 14, 16, 22 in a superimposed relatively fixed relationship.

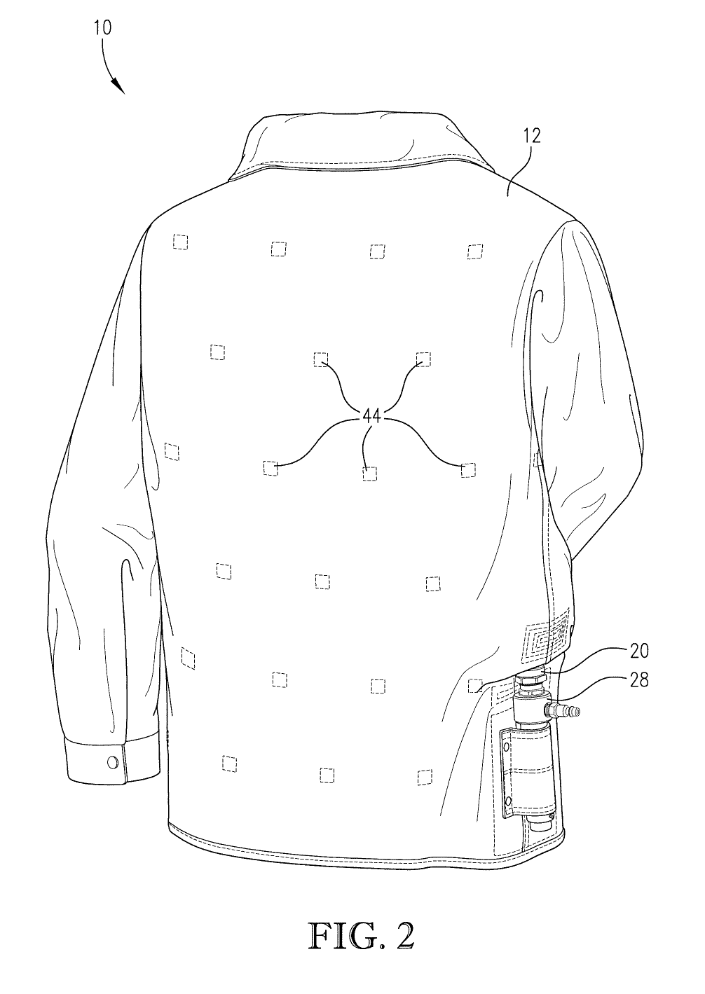

In various embodiments the binding elements 44 are spaced from the peripheries of the layers 12, 14, 16, 22 to join the layers 12, 14, 16, 22 at a plurality of discrete locations. For example, as shown in FIGS. 1-2, the binding elements 44 may be arranged throughout the safety garment 10 to reinforce and support the safety garment 10. Thus, by passing through each of the layers 12, 14, 16, 22 the binding elements 44 may ensure that the layers 12, 14, 16, 22 remained joined and superimposed to prevent blockage of the apertures 18. Further, the binding elements 44 increase the mobility of the wearer by generally preventing the safety garment from puffing out and interfering with the wearer due to reception of the cooling air which is preferably under high pressure conditions.

The binding elements 44 may include any elements or combination of elements operable to pass through each of the layers 12, 14, and 16, or in some embodiments layers 12, 14, 16 and 22, to join the layers 12, 14, 16, 22 together. Thus, in some embodiments, the binding elements 44 may include rivets, bolts, screws, clasps, buttons, zippers, pins, hooks, combinations thereof, and the like. The binding elements 44 preferably include a stitch passing through the outer layer 12, middle layers 14, 22, and inner layer 16 to join and superimpose portions of the layers 12, 14, 16, 22. Thus, for example, the binding elements 44 may include a plurality of discrete stitches sewn through the various layers 12, 14, 16, 22 at a plurality of discrete locations. The stitches employed by the binding elements 44 may be comprised at least partially of a flame-resistant material, such as NOMEX®, to join portions of the garment 10 even in high-temperature environments. However, in some embodiments the stitches may be comprised of conventional natural and synthetic materials. Use of the stitches is most preferred over other coupling elements because stitching material has low heat conductivity and is not likely to transfer exterior heat to the wearer.

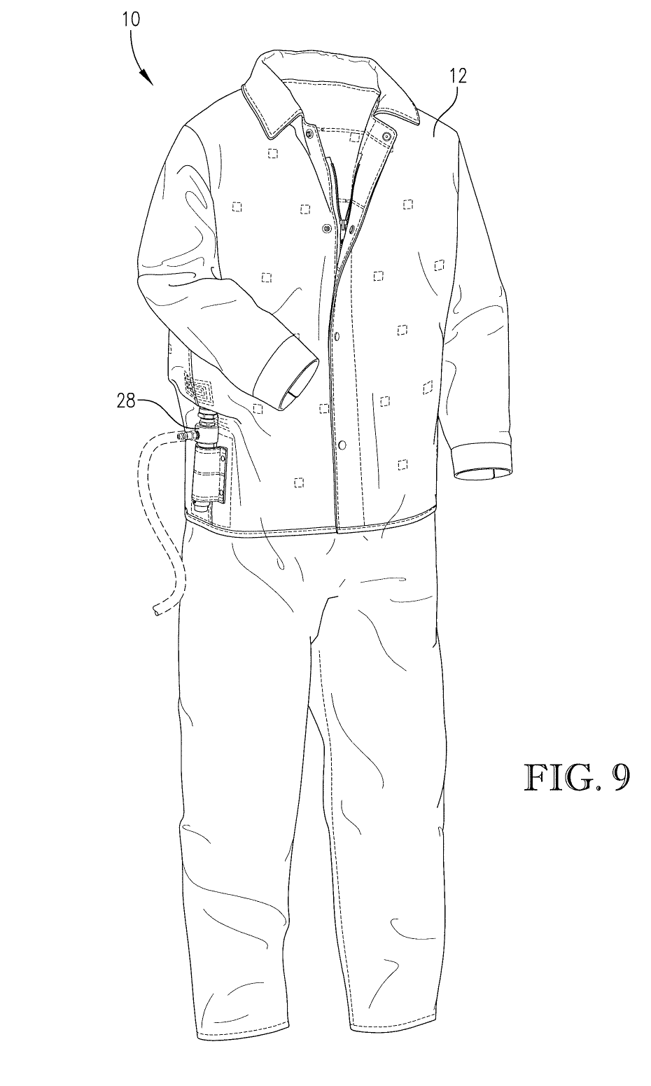

In embodiments where the garment 10 presents a configuration other than a jacket, such as the coverall illustrated in FIG. 9, the sub-unit 24 may be disposed in any portion of the garment 10 to provide cooling air to any portion of the wearer. For example, the sub-unit 24 may be disposed within the jacket and pants illustrated in FIG. 9 to provide cooling air to the wearer's upper and lower body. Alternatively, the sub-unit 24 may be disposed only within the jacket to increase the mobility of the wearer by enabling other portions of the garment 10 to be conventionally constructed.

In operation, the wearer may wear and secure the safety garment 10 in a similar manner to a conventional garment. The wearer, or another individual, may couple an air supply, such as the vortex cooling device 28, and/or an air line to the inlet 20. The inlet 20 directs received cooling air between the outer layer 12 and first middle layer 14, or between the middle layers 14, 22, depending on the configuration of the safety garment 10. The cooling air at least partially fills the gap between the layers 12, 14, or layers 14, 22, and at least some of the cooling air passes through one or more of the apertures 18 to cool the wearer.

The lightweight configuration of the safety garment 10 enables the wearer to perform mobile activities in high-temperature environments, such as welding, forging, or casting, while remaining protected and cooled by the safety garment 10. The safety garment 10 may also be utilized by support technicians in high-temperature environments, such as by the individuals that support workers dressed in less-mobile, or immobile, high-temperature aluminized heat suits.

Various embodiments of the present invention that employ flame-resistant materials may enable the wearer to utilize the safety garment 10 to operate in high-temperature environments up to one-hundred fifty degrees Fahrenheit for extended periods of time. For temperatures even exceeding one-hundred eighty degrees Fahrenheit, embodiments of the safety garment 10 may enable the wearer to safely function for four to five minutes. Thus, even in potentially extreme conditions, the safety garment 10 may be operable to cool the wearer to a suitable temperature.

It is believed that embodiments of the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A safety garment operable to be worn by a wearer, the garment comprising:
a protective outer layer;
a first generally impermeable middle layer coupled with the outer layer;
an inner layer coupled with the first middle layer and operable to be worn against the wearer;
a plurality of apertures formed through the first middle layer and inner layer; and
an inlet coupled with the outer layer and operable to receive cooling air and direct the cooling air between the outer layer and first middle layer to enable the cooling air to pass through at least one of the apertures to cool the wearer.

2. The garment of claim 1, wherein the protective outer layer is comprised of a flame-resistant material.

3. The garment of claim 1, wherein the protective outer layer is comprised of leather.

4. The garment of claim 1, wherein the inner layer is comprised of a flame-resistant material.

5. The garment of claim 1, further including a binding element passing through the outer layer, first middle layer, and inner layer to join portions of the layers in a superimposed relatively fixed relationship.

6. The garment of claim 1, wherein the first middle layer and inner layer are coupled together in proximity to at least one of the apertures.

7. The garment of claim 6, wherein at least a first set of the apertures are linearly disposed along the first middle layer and inner layer and the first middle layer and inner layer are joined together generally parallel to the first set of apertures.

8. The garment of claim 7, wherein the first middle layer and inner layer are stitched together along opposite sides of the first set of apertures.

9. The garment of claim 1, further including a second generally impermeable middle layer coupled with the outer layer, the inlet being operable to direct cooling air between the second middle layer and first middle layer.

10. The garment of claim 1, wherein the outer layer includes a reinforced portion and the inlet is coupled with the reinforced portion.

11. The garment of claim 1, wherein the garment is a jacket.

12. A safety garment operable to be worn by a wearer, the garment comprising:
a protective outer layer;
a first generally impermeable middle layer;
a second generally impermeable middle layer coupled with the outer layer;
an inner layer coupled with the first middle layer and operable to be worn against the wearer;
a plurality of apertures formed through the first middle layer and inner layer;
an inlet coupled with the outer layer and operable to receive cooling air and direct the cooling air between the first middle layer and second middle layer to enable the cooling air to pass through at least one of the apertures to cool the wearer; and
a plurality of binding elements each passing through the outer layer, first middle layer, second middle layer, and inner layer to join portions of the layers in a superimposed relatively fixed relationship.

13. The garment of claim 12, wherein the outer layer and inner layer are comprised of a flame-resistant material.

14. The garment of claim 12, wherein the first middle layer and inner layer are coupled together in proximity to at least one of the apertures.

15. The garment of claim 14, wherein at least a first set of the apertures are linearly disposed along the first middle layer and inner layer and the first middle layer and inner layer are joined together generally parallel to the first set of apertures.

16. The garment of claim 15, wherein the first middle layer and inner layer are stitched together along opposite sides of the first set of apertures.

17. The garment of claim 12, wherein the garment is a jacket.

18. The garment of claim 12, wherein the outer layer includes a reinforced portion and the inlet is coupled with the reinforced portion.

19. A safety garment operable to be worn by a wearer, the garment comprising:
a flame-resistant outer layer including a reinforced portion;
a first generally impermeable middle layer;
a second generally impermeable middle layer coupled with the outer layer;
a flame-resistant inner layer coupled with the first middle layer and operable to be worn against the wearer;
a plurality of apertures formed through the first middle layer and inner layer, wherein at least a first set of the apertures are linearly disposed along the first middle layer and inner layer and the first middle layer and inner layer are stitched together along opposite sides of the first set of apertures;
an inlet coupled with the reinforced portion of the outer layer and operable to receive cooling air and direct the cooling air between the first middle layer and second middle layer to enable the cooling air to pass through at least one of the apertures to cool the wearer; and
a plurality of binding elements each passing through the outer layer, first middle layer, second middle layer, and inner layer to join portions of the layers in a superimposed relatively fixed relationship.

20. The garment of claim 19, wherein at least one of the binding elements includes a stitch passing through the outer layer, middle layers, and inner layer.

21. The garment of claim 19, wherein the garment is a jacket.

22. The garment of claim 19, wherein the binding elements are spaced from the edges of the layers.

23. The garment of claim 19, further including a vortex cooling device having a cool air output and a hot air output, the cool air output operable to be coupled with the inlet to provide the cooling air thereto.

24. The garment of claim 23, wherein the reinforced portion of the outer layer includes a first reinforced area disposed in proximity to the inlet and a second reinforced area disposed in proximity to the hot air output of the vortex cooling device.

25. The garment of claim 19, wherein the reinforced portion of the outer layer comprises leather.
